(19) United States
(12) Patent Application Publication
(10) Pub. No.: US 2009/0098823 A1
(43) Pub. Date: Apr. 16, 2009

(54) COMMUNICATION SYSTEM, RELAY DEVICE, AND RELAY METHOD

(76) Inventor: YOSHINORI MIYAMOTO, Tokyo (JP)

Correspondence Address: NEC CORPORATION OF AMERICA, 6535 N. STATE HWY 161, IRVING, TX, 75039, US

(21) Appl. No.: 12/249,610

(22) Filed: Oct. 10, 2008

(30) Foreign Application Priority Data
Oct. 10, 2007 (JP) 2007-264524

(51) Int. Cl. H04B 1/60

(52) U.S. Cl. 455/9

(57) ABSTRACT

A relay device for relaying a packet communication between communication devices; comprising: communication quality parameter conversion means for converting a communication quality parameter described in a received quality information notification packet into a communication quality parameter measured by the relay device from a received data packet.

### INCORPORATION BY REFERENCE

This application is based upon and claims the benefit of priority from Japanese patent application No. 2007-264524, filed on Oct. 10, 2007, the disclosure of which is incorporated herein in its entirety by reference.

### BACKGROUND OF THE INVENTION

1. Field of the Invention

The present invention relates to a relay device including a quality information notification function capable of detecting or measuring a communication quality and capable of notifying a transmitting device of a detected or measured communication quality parameter in a communication system in which one terminal device transmits a packet to another terminal device and the relay device is disposed on a communication section between the terminal devices, and a communication system including the relay device, and a relay method for the relay device.

2. Description of the Related Art

In real-time media communication, it can be said that ideal communication is such that each data packet continuously transmitted from a transmitting device is transferred to a receiving device without exceeding preset certain transmission time and without packet loss. Further, a “communication quality parameter” such as a transmission delay, a jitter or a discard rate for data packets on a communication section generated to follow transmission of real-time data has a great influence on reproducing of data in a receiving device.

The real-time media communication uses RTP (Real-time Transport Protocol)/RTCP (RTP Control Protocol) as a communication protocol to manage the communication quality parameters. Research and development of a method of measuring communication quality parameters, a communication method control method and the like are underway in various institutions.

As related techniques, a technique for causing a transmitting device to adjust a bit rate of transmission data and adjust an error correcting level based on feedback information including a jitter or a loss rate for reception packets and measured by a receiving device is disclosed in Japanese Patent Application Laid-Open No. 2002-204278. With this technique, the receiving device notifies the transmitting device of a communication quality parameter measured from a data packet reception state, whereby the transmitting device can optimize a data packet communication method. As a result, the receiving device reproduces real-time media with high quality.

However, if mobile terminals are included in transmitting devices or receiving devices transmitting or receiving real-time media, wired sections and wireless sections such as access points and wireless base stations are normally used simultaneously on a communication path. In this respect, degradation in transmission quality particularly due to transmission error has greater influence particularly on the wireless sections than the wired sections. Due to this, it is desired to ensure high communication quality specialized in the wireless sections.

However, with the technique disclosed in the Japanese Patent Application Laid-Open No. 2002-204278, the communication parameter such as packet discard rate, the jitter or the packet delay time measured by the receiving device has a value integrally estimating the entire communication path without discrimination between the two different types of sections, i.e., the wired sections and the wireless sections on the communication path from the transmitting device to the receiving device. Due to this, a communication method specialized in the wireless sections is not optimized only by causing the transmitting device to control the communication method based on the communication quality parameters.

In view of these problems, a pamphlet of International Patent Application Publication No. 2005/027394 discloses a transmission technique for causing each wireless base station disposed at a boundary point between one wired section and one wireless section to calculate a communication quality parameter in the wireless section and to use a communication method appropriate for the wireless section based on the calculated communication quality parameters.

A content of the communication quality parameter disclosed in the pamphlet of the International Patent Application Publication No. 2005/027394 includes a packet discard rate, a jitter, packet delay time or the like. Examples of the communication method include a data packet retransmission count control, an error correction level control, and a transmission priority control.

With the technique disclosed in the pamphlet of the International Patent Application Publication No. 2005/027394, the wireless base station relays an RTP packet from a transmitting device, thereby measuring a communication parameter in the wired section from the transmitting device to the wireless base station. Furthermore, the wireless base station refers to contents of an RTCP packet fed back from a receiving-side mobile terminal (terminal device) to the transmitting device, thereby grasping integral communication quality parameter in the wired section and the wireless section from the transmitting device to the receiving-side mobile terminal. The wireless base station calculates a difference between the integral communication quality parameter in the wired section and the wireless section and those in the wired section, thereby making it possible to calculate a communication quality parameter in the wireless section. As a result, the wireless base station can use an appropriate communication method for the wireless section according to the calculated current communication quality in the wireless section. Namely, by using the technique disclosed in the pamphlet of the International Patent Application Publication No. 2005/027394, a receiving device can receive a data packet by an appropriate communication method specialized in the wired section if the receiving device receives the data packet from the wireless base station.

By using the above-stated conventional technique, the wireless base station can grasp the communication quality parameter in the wireless section from the wireless base station to the receiving-side terminal device. Due to this, the wireless base station can transmit a packet to the receiving-side terminal device using the appropriate communication method for the wireless section. However, no considerations are given to a method for causing the receiving-side terminal device to transmit a packet using an appropriate communication method for a wireless section opposite in a direction to the wireless section from the wireless base station to the receiving-side terminal device.

Due to this, with the conventional technique, a transmitting-side terminal device cannot transmit a packet using an appropriate communication method for a wireless section from the transmitting-side terminal device to a relay device such as the wireless base station in a communication system in which a packet is transmitted from the transmitting-side terminal device to a receiving-side terminal device and the relay device is disposed on a communication section between the transmitting-side terminal device and the receiving-side terminal device. This follows that a packet cannot be transmitted using an appropriate communication method for a communication section from a transmitting-side terminal device to a relay device whether the communication section is wired or wireless. This problem is not limited to an instance in which a transmitting-side communication device is a terminal device. A packet cannot be transmitted using an appropriate communication method for a communication section from a certain relay device to each of all other relay devices if the certain relay device transmits (or transfers) the packet to each of all the other relay devices.

Examples of the relay device include a wireless base station, a public wireless LAN, a router, and a gateway. Examples of the terminal device include a portable telephone, a PDA (Personal Digital Assistance), and a PC (Personal Computer).

Therefore, the problem to be solved by the present invention is that an appropriate communication method for a communication section between two communication devices out of all communication devices except for a receiving-side terminal device if a packet is transmitted (transferred) between the two communication devices.

### SUMMARY OF THE INVENTION

It is, therefore, an object of the present invention to provide a communication device including a quality information notification function capable of acquiring a communication quality parameter on a communication section between two communication devices out of all communication devices except for a receiving-side terminal device, that is, a communication section from a communication device transmitting (or transferring) a packet to a communication device receiving the packet if the packet is transmitted (or transferred) between the two communication devices in a communication system in which each terminal device transmits a packet to another terminal device and a relay device is disposed on a communication section between the terminal devices, and the communication system including the communication device, and a relay method for the communication device.

According to the present invention, there is provided a relay device for relaying a packet communication between communication devices; comprising: communication quality parameter conversion means for converting a communication quality parameter described in a received quality information notification packet into a communication quality parameter measured by the relay device from a received data packet.

In addition, according to the present invention, there is provided a communication device transmitting and receiving packets, comprising a function as the relay device according to claim 1, and further comprising:transmission means for transmitting a data packet using a transmission method according to a communication interval based on the communication quality parameter.

Further, according to the present invention, there is provided a communication system in a network, comprising a transmission device and a receiving device communicating a data packet and a communication quality notification packet therebetween, further comprising: the relay device according to claim 1, wherein the relay device relays the data packet and the communication quality notification packet.

Still further, there is provided a relay method for relaying a packet communication between communication methods; comprising: a communication quality parameter conversion step of converting a communication quality parameter described in a received quality information notification packet into a communication quality parameter measured by the relay device from a received data packet.

Further more, there is provided a relay program for relaying a packet communication between communication devices causing a computer to execute: a communication quality parameter conversion function of converting a communication quality parameter described in a received quality information notification packet into a communication quality parameter measured by the relay device from a received data packet.

### BRIEF DESCRIPTION OF THE DRAWINGS

FIG. 1 is a configuration diagram of a communication system according to a first embodiment of the present invention;

FIG. 2 is an internal block diagram of a relay device including a communication quality notification function according to the first embodiment of the present invention;

FIG. 3 is a sequence diagram showing a sequence for a data packet transmission operation from a transmitting device to a receiving device according to the first embodiment of the present invention;

FIG. 4 is a sequence diagram showing a sequence for a feedback information packet transmission operation from the receiving device to the transmitting device according to the first embodiment of the present invention;

FIG. 5 is a block diagram of a communication system performing real-time media streaming according to a second embodiment of the present invention;

FIG. 6 is a sequence diagram showing a sequence for a data packet transmission operation from a transmitting device to a receiving device according to the second embodiment of the present invention;

FIG. 7 is a sequence diagram showing a sequence for a feedback information packet transmission operation from the receiving device to the transmitting device according to the second embodiment of the present invention; and

FIG. 8 is a sequence diagram of an operation sequence for transmitting an information packet according to the second embodiment of the present invention.

### DETAILED DESCRIPTION OF THE INVENTION

Embodiments of the present invention will be described hereinafter with reference to the accompanying drawings.

### First Embodiment

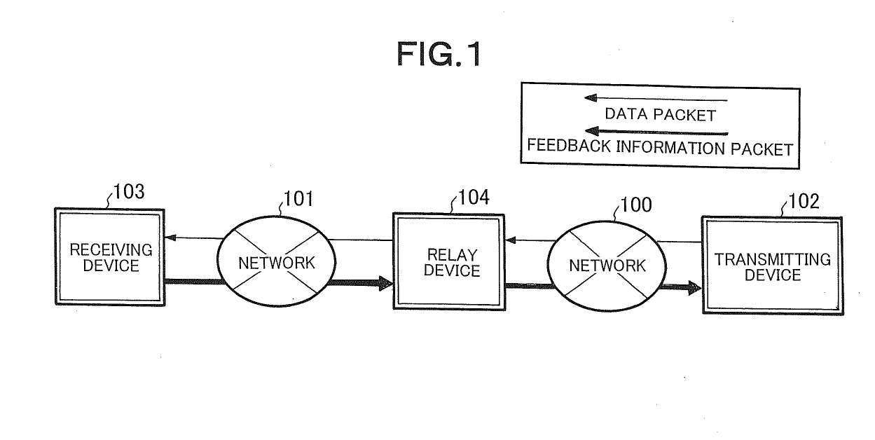

FIG. 1 is a configuration diagram showing a configuration of a communication system according to a first embodiment of the present invention.

As shown in FIG. 1, the communication system according to the first embodiment of the present invention includes a network 100, a network 101, a transmitting device 102, a receiving device 103, and a relay device 104. The transmitting device 102 and the receiving device 103 are communication devices according to the first embodiment, respectively.

Each of the networks 100 and 101 is a communication network for transmitting a packet by making correct routing with the packet addressed to a destination address. The transmitting device 102 is connected to the relay device 104 via the network 101. Likewise, the relay device 104 is connected to the receiving device 103 via the network 100.

The relay device 104 according to the first embodiment is advantageous particularly if the networks 101 and 102 greatly differ in network communication characteristics, for example, one of the networks 100 and 101 is a wired section and the other is a wireless section. The reason is as follows. Because of the great difference in network communication characteristics between the networks 100 and 101 in the communication system, the networks 100 and 101 also differ in an appropriate communication method. Due to this, the relay device 104 according to the first embodiment capable of adopting appropriate communication methods for the networks 100 and 101 is desirably disposed at a boundary point between communication sections different in communication characteristics.

Specific examples of the great difference in communication characteristics between the networks 100 and 101 include an example in which one of the networks 100 and 101 is a wireless link and the other is a wired network such as Ethernet (registered trademark) network or ADSL. Examples of the relay device 104 for the example in which one of the networks 100 and 101 is a wireless link and the other is a wired network include a wireless base station, an access point of a public wireless LAN, a router, and a gateway.

However, the communication device according to the first embodiment is applicable to any types of the communication sections, that is, the networks 100 and 101. Namely, even if both the networks 100 and 101 are wired sections or wireless sections, the communication device according to the first embodiment is applicable to the communication sections, that is, the networks 100 and 101. Even if the networks 100 and 101 are a wired section and a wireless section, respectively, and the communication device according to the first embodiment is applicable to the communication sections, that is, the networks 100 and 101.

The transmitting device 102 is the communication device transmitting real-time media to the receiving device 103. The relay device 104 transfers a data packet transmitted from the transmitting device 102 to the receiving device 103 and also transfers a feedback information packet received from the receiving device 103 to the transmitting device 102.

The receiving device 103 is the communication device decoding the received data packet to an image/a voice. The receiving device 103 also notifies the transmitting device 102 via the relay device 104 of a communication quality parameter acquired by measuring a reception state of the received data packet as the feedback information packet.

The transmitting device 102 can further include a function as the receiving device 103 and the receiving device 103 can further include a function as the transmitting device 102. In this case, the relay device 104 functions as the relay device 104 according to the first embodiment on both an up transmission path and a down transmission path (that is, irrespectively of whether one of the communication devices 102 and 103 functions as a transmitting device and the other functions as a receiving device).

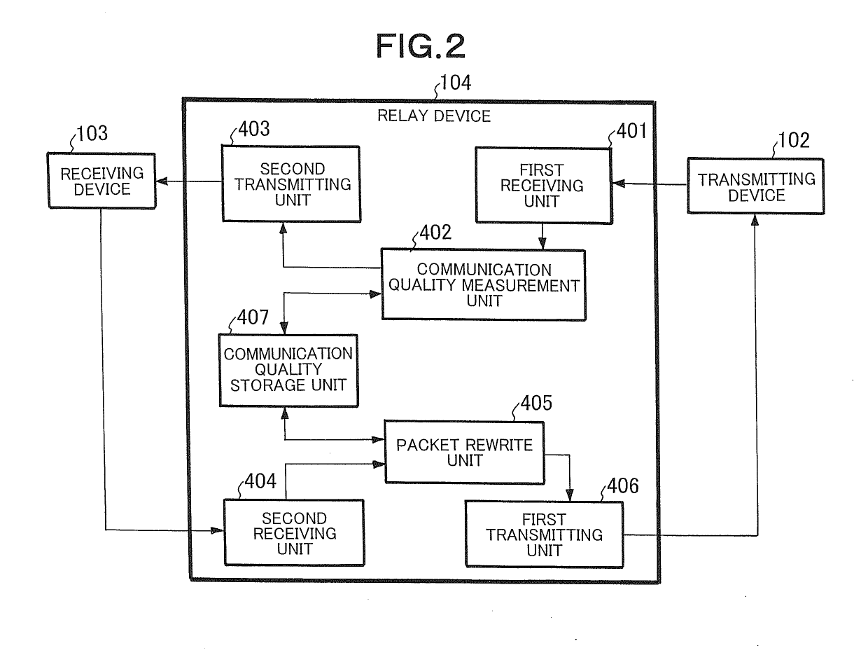

FIG. 2 is a block diagram for describing an internal configuration of the relay device 104 including a quality notification function according to the present invention in detail.

The relay device 104 includes a first receiving unit 401, a communication quality measurement unit 402, a second transmitting unit 403, a second receiving unit 404, a packet rewrite unit 405, a first transmitting unit 406, and a communication quality parameter storage unit 407.

The first receiving unit 401 is a data packet receiving unit receiving a data packet on the down transmission path from the transmitting device 102 to the receiving device 103.

The communication quality measurement unit 402 decides a communication quality parameter based on a sequence number and time information such as a timestamp of the received data packet. The communication quality measurement unit 402 stores the communication quality parameter in the communication quality parameter storage unit 407 while linking the communication quality parameter to a transmission source (hereinafter, “source”) address of the data packet.

The second transmitting unit 403 is a data packet transmitting unit on the down transmission path from the transmitting device 102 to the receiving device 103. The second receiving unit 404 is a feedback information packet receiving unit on the up transmission path from the receiving device 103 to the transmitting device 102.

The packet rewrite unit 405 receives the feedback information packet and reads a transmission destination (hereinafter, “destination”) address. The packet rewrite unit 405 requests the communication quality parameter storage unit 407 to notify the linked communication quality parameter corresponding to the read destination address. Further, the packet rewrite unit 405 rewrites contents of the received feedback information packet to the communication quality parameter received from the communication quality parameter storage unit 407.

The first transmitting unit 406 is a feedback information packet transmitting unit on the up transmission path from the receiving device 103 to the transmitting device 102.

The communication quality parameter storage unit 407 is a unit holding information identifying each communication device (“identification information”) and a communication quality parameter while linking the identification information to the communication quality parameters. Examples of the identification information include an IP address.

Furthermore, if receiving a communication parameter notification request with the source address designated, the communication quality parameter storage unit 407 notifies a requester of the communication quality parameter linked to the designated source address. At this time, examples of the communication quality parameter include a packet discard rate, a packet delay time, and a jitter.

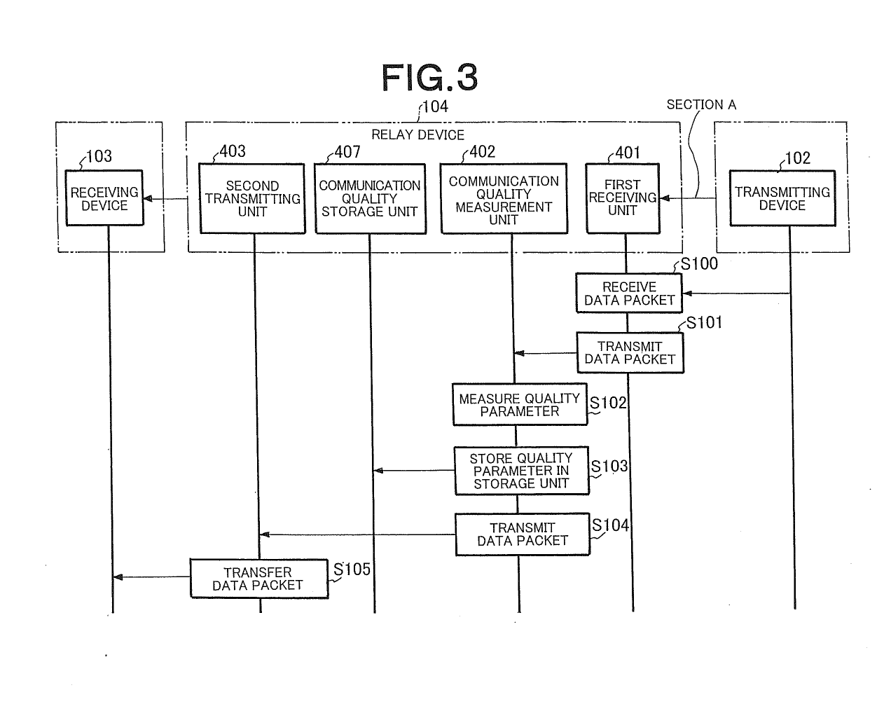

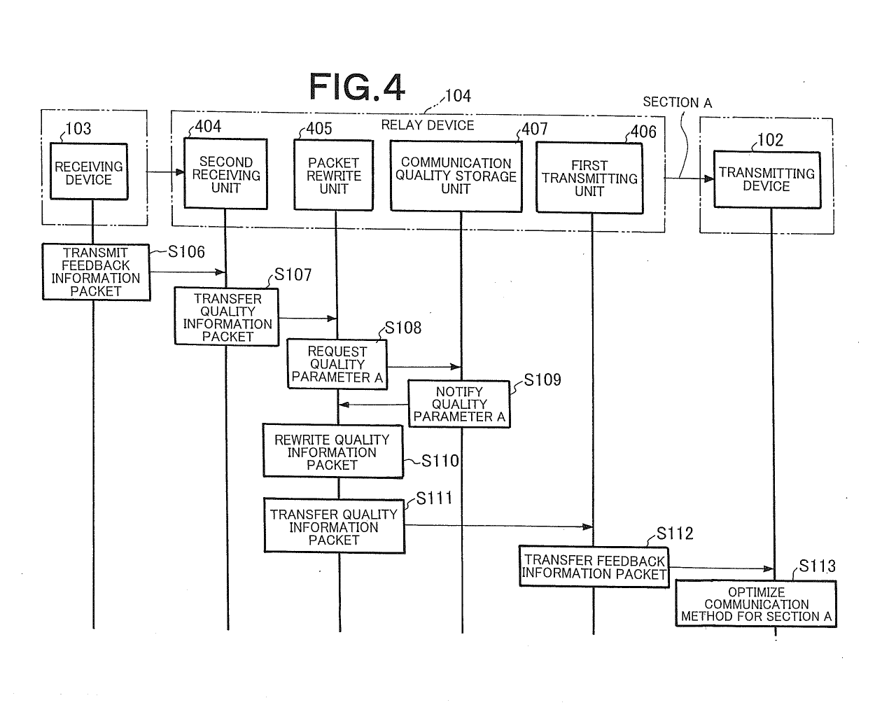

Referring to FIGS. 3 and 4, overall operation of the communication system according to the first embodiment will next be described in detail. For convenience of description, a path from the transmitting device 102 to the relay device 104 is assumed as a section A.

FIG. 3 shows a data packet transmission operation from the transmitting device 102 to the receiving device 103. The first receiving unit 401 of the relay device 104 receives a data packet transmitted from the transmitting device 102 to the receiving device 103 (step S100). The first receiving unit 401 also transmits the received data packet to the communication quality measurement unit 402 (step S101).

The communication quality measurement unit 402 reads a sequence number and time information such as a timestamp from the received data packet, thereby measuring a communication quality parameter (step S102).

Further, the communication quality measurement unit 402 stores the source address of the data packet and the measured communication quality parameter in the communication quality parameter storage unit 407 while linking the source address to the communication quality parameter (step S103). The communication quality parameter measured at this time will be referred to as “communication quality parameter A” on the section A.

Next, the communication quality measurement unit 402 transmits the data packet to the second transmitting unit 403 (step S104). The second transmitting unit 403 transmits the received data packet to the receiving device 103 (step S105).

FIG. 4 shows transmission operation if the receiving device 103 transmits the feedback information packet to the transmitting device 102 according to necessity. The feedback information packet is an information packet in which the communication quality parameter such as a packet loss rate, a transmission delay or a jitter is described.

It is to be noted that the receiving device 103 is configured to measure the communication quality parameter by reading the sequence number and the time information such as the timestamp.

The receiving device 103 transmits a feedback information packet to the second receiving unit 404 (step S106). The second receiving unit 404 transfers the received feedback information packet to the packet rewrite unit 405 (step S107).

The packet rewrite unit 405 reads a destination address of the received feedback information packet. The packet rewrite unit 405 designates the source address (which refers to the address stored as the source address in the step S103) corresponding to the read destination address, and request the communication parameter storage unit 407 to notify the communication quality parameter stored in the communication parameter storage unit 407 (step S108).

The communication quality parameter storage unit 407 notifies the packet rewrite unit 405 of the communication quality parameter A compatible with the source address designated by the packet rewrite unit 405 among the communication quality parameters measured in the step S102 (step S109).

The packet rewrite unit 405 rewrites a value of the communication quality parameter described in the feedback information packet received from the second receiving unit 404 to the communication quality parameter A (step S110). Further, the packet rewrite unit 405 transfers the feedback information packet in which the communication quality parameter is rewritten to the communication quality parameter A to the first transmitting unit 406 (step S111). The first transmitting unit 406 transfers the received feedback information packet to the transmitting device 102 (step S112).

As a result, the transmitting device 102 can grasp the communication quality parameter A on the section A. The transmitting device 102 optimizes a data packet communication method on the section A based on the communication quality parameter A on the section A (step S113).

By applying the communication device according to the first embodiment to an IP relay device, the transmitting device 102 can use an appropriate communication method for the section A if the transmitting device 102 includes a transmission control function using the grasped communication quality parameter on the section A. It is to be noted that the transmitting device 102 is configured to be able to use an appropriate packet communication method based on communication quality parameter.

Moreover, the relay device 104 can grasp a communication quality parameter on a communication section between the relay device 104 and the receiving device 103 by calculating a difference between the communication quality parameter read from the feedback information packet and the communication quality parameter A on the section A. Accordingly, the relay device 104 may be configured to optimize a data packet communication method on the communication section between the relay device 104 and the receiving device 103 based on the grasped communication quality parameters.

### Second Embodiment

A second embodiment of the present invention will be described in detail with reference to the drawings. By applying a relay device including a quality information notification function according to the present invention to each of a plurality of relay devices on communication sections, the relay device can be used to improve packet transmission quality.

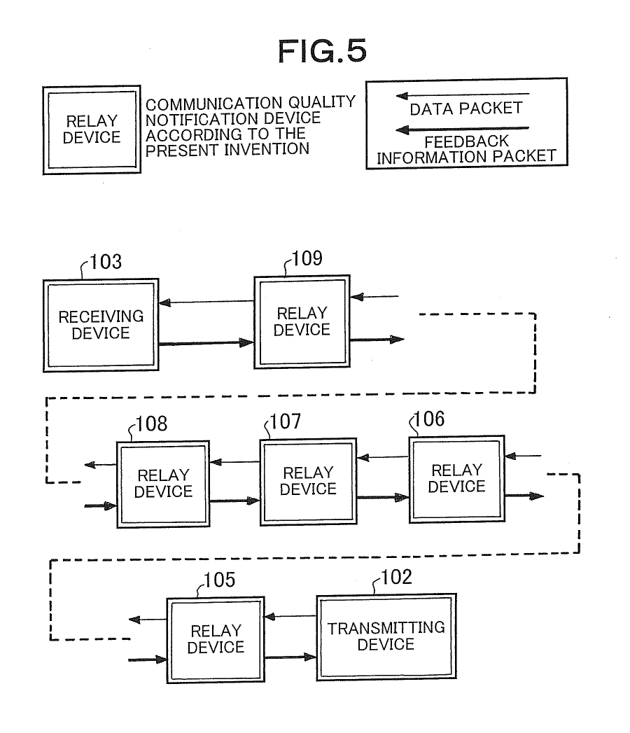

FIG. 5 shows a communication system according to the second embodiment. The communication system includes a transmitting device 102, a receiving device 103, and relay devices 105 to 109. Since the transmitting device 102 and the receiving device 103 are similar in configuration to those according to the first embodiment, they will not be repeatedly described herein. Further, since the relay devices 105 to 109 are similar in configuration to the relay device 104 according to the first embodiment, they will not be repeatedly described herein. Similarly to the first embodiment, the transmitting device 102 can further include a function as the receiving device 103 and the receiving device 103 can further include a function as the transmitting device 102.

Each of the relay devices 105 to 109 is a relay device transferring a data packet transmitted from the transmitting device 102 to the receiving device 103 by making correct routing and transferring a feedback information packet received from the receiving device 103 to the transmitting device 102 by making correct routing. Examples of the relay devices 105 to 109 include routers, gateways, wireless base stations, and access points.

The second embodiment shows one of network configuration examples in which a plurality of relay devices according to the present invention is disposed on communication sections between a transmitting device and a receiving device. The network configuration is not necessarily similar to that of the second embodiment so as to realize the present invention.

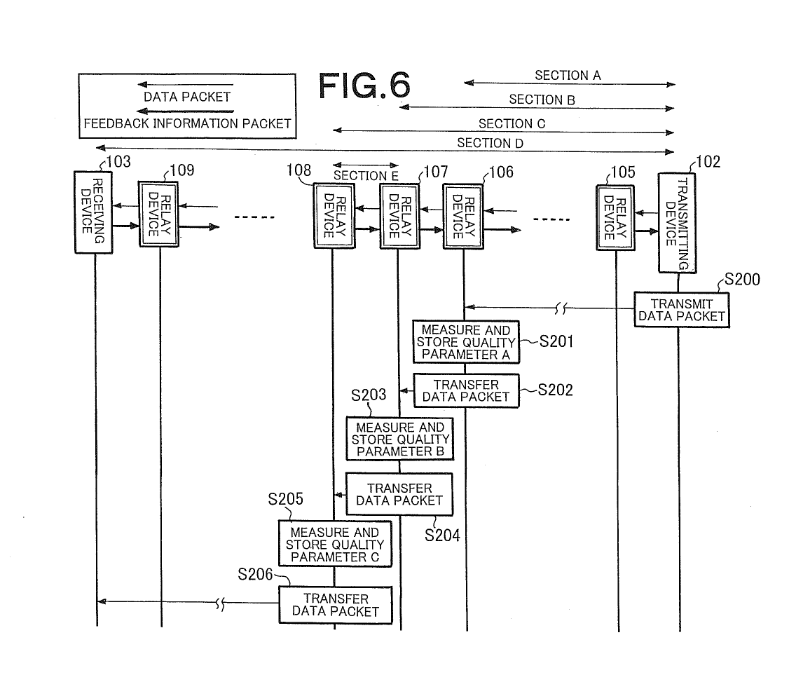

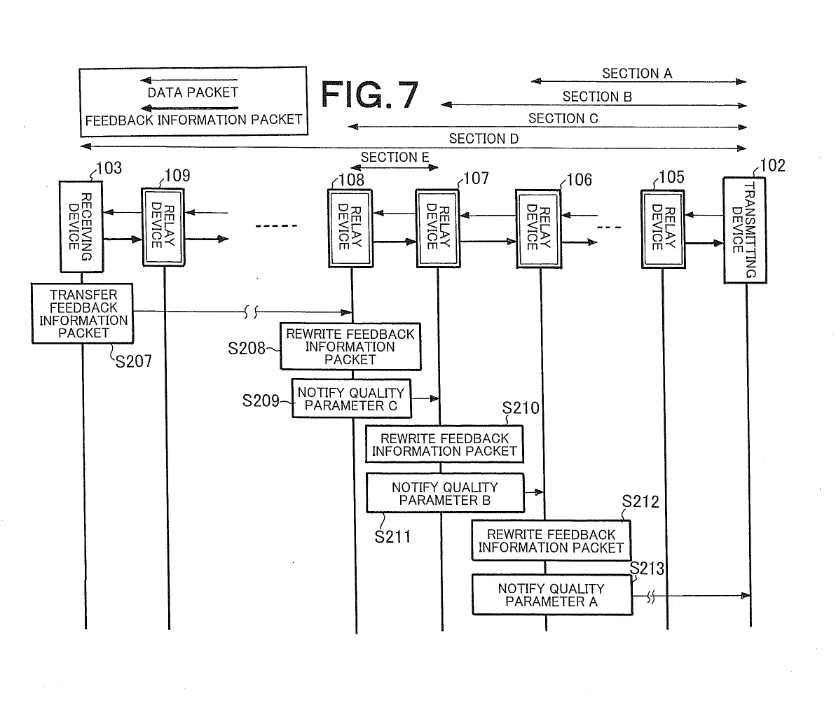

Referring to FIGS. 6 and 7, overall transmission operation of the communication system according to the second embodiment will be described. For convenience of description, a path from the transmitting device 102 to the relay device 106 is assumed as a section A, a path from the transmitting device 102 to the relay device 107 is assumed as a section B, and a path from the transmitting device 102 to the relay device 108 is assumed as a section C. Further, a path from the transmitting device 102 to the receiving device 103 is assumed as a section D and a path from the relay device 107 to the relay device 108 is assumed as a section E.

FIG. 6 shows a detailed transmission signal operation sequence if the transmitting device 102 transmits a data packet to the receiving device 103. The relay devices 105 to 109 transfer the data packet transmitted from the transmitting device 102 to the receiving device 103 by performing similar operation sequences to that of the steps S100 to S105 shown in FIG. 3.

In the second embodiment, the overall operation sequence of the relay devices 105 to 109 will be described while paying attention particularly to the relay devices 106, 107, and 108 in the detailed transmission signal operation sequence.

Each of the relay devices on a communication section from the relay device 105 to the relay device 106 performs a transmission operation in the steps S100 to S105 shown in FIG. 3, thereby transferring the data packet transmitted from the transmitting device 102 to the relay device 106 (step S200).

The relay device 106 measures and records a communication quality parameter A on the section A from the received data packet by performing the transmission operation in the steps S100 to S103 shown in FIG. 3 (step S201). The relay device 106 transfers the data packet to the relay device 107 by performing the transmission operation in the steps S104 to S106 (step S202).

The relay device 107 measures and records a communication quality parameter B on the section B by performing the transmission operation in the steps S100 to S105 shown in FIG. 3 (step S203), and transfers the data packet to the relay device 108 (step S204).

Likewise, the relay device 108 measures and records a communication quality parameter C on the section C by performing the transmission operation in the steps S100 to S105 shown in FIG. 3 (step S205), and transfers the data packet to a next relay device. Thereafter, each of the relay devices disposed on a communication path from the relay device 108 to the receiving device 103 repeatedly performs a similar transmission operation and transfers the data packet to the receiving device 103 (step S206).

At this time, each of the relay devices 105 to 109 disposed on communication sections from the transmitting device 102 to the receiving device 103 holds one communication quality parameter on the communication section from the transmitting device 102 to each relay device.

FIG. 7 shows a detailed transmission signal operation sequence if the receiving device 103 transmits a communication quality parameter judged from a data packet reception state to the transmitting device 102 as the feedback information packet.

At this time, the communication quality parameter described in the feedback information packet transmitted from the receiving device 13 is a communication quality parameter D on the section D. If the receiving device 103 transmits the feedback information packet to the transmitting deice 102, the relay devices 109 to 105 perform similar operation sequences to that of the steps S107 to S112 shown in FIG. 4, thereby transferring the feedback information packet transmitted from the receiving device 103 to the transmitting device 102. 5 In this respect, the overall operation sequence of the relay devices 109 to 105 will be described while paying attention to the relay devices 106, 107, and 108.

Each of the relay devices disposed on a communication path from the receiving device 103 to the relay device 108 performs a transmission operation similar to that of the steps S107 to S112 shown in FIG. 4, thereby transferring the feedback information packet transmitted from the receiving device 103 to the relay device 108 (step S207).

The relay device 108 performs a transmission operation similar to that of the steps S107 to S110, thereby rewriting a content of the received feedback information packet to the communication quality parameter C decided in the step S205 (Step S208). Further, the relay device 108 performs a transmission operation similar to that of the steps S111 to S112, thereby transferring the feedback information packet to the relay device 107 (step S209).

Similarly to the relay device 108, the relay device 107 performs the transmission operation similar to that of the steps S107 to S110, thereby rewriting the content of the received feedback information packet to the communication quality parameter B decided in the step S203 (Step S210). Further, the relay device 107 performs the transmission operation similar to that of the steps S111 to S112, thereby transferring the feedback information packet to the relay device 106 (step S211).

Similarly to the relay device 108, the relay device 106 performs the transmission operation similar to that of the steps S107 to S110, thereby rewriting the content of the received feedback information packet to the communication quality parameter A decided in the step S201 (step S212). Further, the relay device 106 performs the transmission operation similar to that of the steps S111 to S112, thereby transferring the feedback information packet to the adjacent relay device closer to the transmitting device 102. Thereafter, each of the relay devices disposed on a communication path from the relay device 106 to the transmitting device 102 repeatedly performs similar transmission operations, thereby transferring the feedback information packet to the transmitting device 102 (step S213).

In this way, the relay devices 105 to 109 sequentially rewrite the content of the feedback information packet transmitted from the receiving device 103. Each relay device can, therefore, notify the adjacent relay device closer to the transmitting device 102 (the adjacent relay device corresponds to the transmitting device 102 if the previous relay device is the relay device 105) of the measured communication quality parameters.

In this respect, if each of the relay devices 105 to 109 includes a packet content read unit reading a communication quality parameter from the feedback information packet, a communication quality calculation unit calculating a difference between the read communication quality parameter and the communication quality parameter held by the communication quality measurement unit 402, and a transmission control unit and the transmitting device 102 includes a transmission control unit, real-time media can be transmitted with high quality according to the second embodiment.

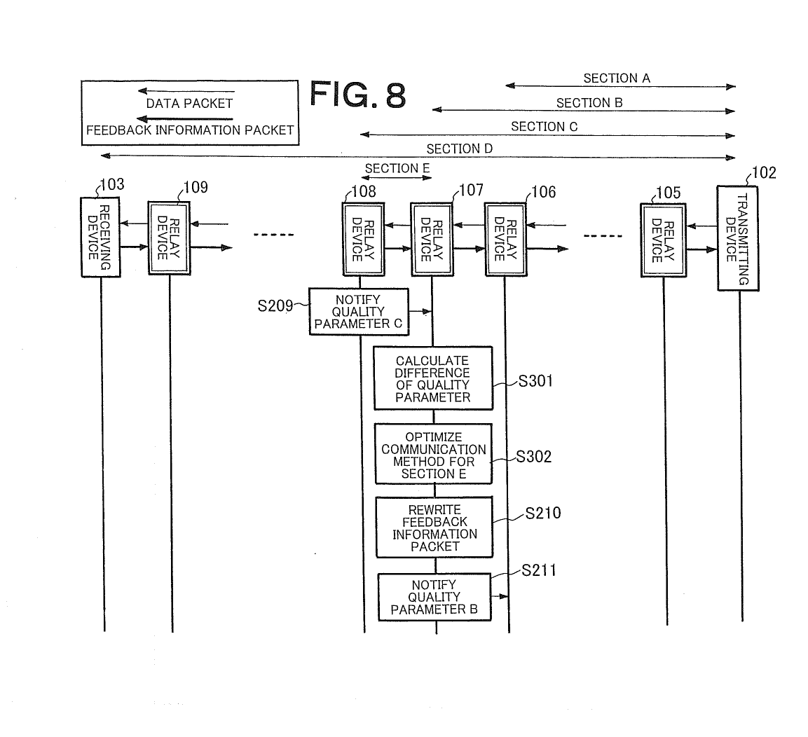

The reason for this will be described while taking the transmission operations performed by the relay devices 106, 107, and 108 as an example with reference to FIG. 8.

In a step S209, the relay device 107 is notified of the communication quality parameter C from the relay device 108 and holds the communication quality parameter C in the packet content read unit.

The communication quality parameters held in the relay device 107 at this time are the communication quality parameter C and the communication quality parameter B on the section B measured in the step S203. By causing the communication quality calculation unit 402 to calculate the difference between the two communication quality parameters B and C, a communication quality parameter E on the section E can be calculated (step S301).

A method of calculating the communication quality parameter E on the section E if the communication quality parameter E is the packet discard rate or the jitter will be described specifically. It is to be noted that the packet discard rate or the jitter is only an example and is not intended to limit the content of the communication parameter according to the second embodiment. As long as information enables measuring a communication quality on a communication path, even the information other than the packet discard rate or the jitter can be used as the communication quality parameter.

If the communication quality parameter measured by each relay device according to the second embodiment is the packet discard rate, the communication quality parameter E is calculated by the following calculation equation.

Packet discard rate E [%](100×(C [%]−B [%]))/(100−B [%])

Moreover, if the communication quality parameter measured by each relay device according to the second embodiment is the jitter, the communication quality parameter E is calculated by the following calculation equation.

Jitter E [ms]=C [ms]−B [ms]

If the relay device 107 transfers the data packet received from the relay device 106 to the relay device 108, the relay device 107 can exercise a transmission control using the communication quality parameter E calculated in the transmission operation stated above and can thereby use an appropriate communication method for the section E (step S302). In addition, the relay device 107 performs the transmission operation similar to that of the steps S210 and S211.

As a result, according to the second embodiment, the communication quality parameters between the communication sections of the communication system including the transmitting device 102, the receiving device 103, and the relay device 105 to 109 can be acquired. Appropriate communication methods for the communication sections can be used based on the acquired communication quality parameters, respectively.

In the first and second embodiments, an IP address is used as the information identifying each communication device. Alternatively, a network address that is an address representing a network on which a communication device is present can be used as the information identifying the communication device.

The relay device according to the present invention can be constructed by hardware. Alternatively, the relay device according to the present invention can be constructed by causing a computer to read and execute a program for allowing the computer to function as the relay device according to the present invention.

The present invention can be applied to an IP relay device disposed on a communication path between transmitting or receiving devices in a communication system and can be used to improve packet transmission quality. Examples of the IP relay device include a wireless base station of a portable terminal, an access point of a public wireless LAN, a router, and a gateway. The present invention can be further applied to a relay device in a dynamically generated network such as an ad hoc network besides a statically generated network.

Although the exemplary embodiments of the present invention have been described in detail, it should be understood that various changes, substitutions and alternatives can be made therein without departing from the sprit and scope of the invention as defined by the appended claims. Further, it is the inventor's intent to retain all equivalents of the claimed invention even if the claims are amended during prosecution.

What is claimed is:

1. A relay device for relaying a packet communication between communication devices; comprising:
communication quality parameter conversion means for converting a communication quality parameter described in a received quality information notification packet into a communication quality parameter measured by the relay device from a received data packet.

2. The relay device according to claim 1, further comprising:
parameter measurement means for measuring a communication quality parameter based on time information described in the received data packet,
wherein the communication quality parameter used by the communication quality parameter conversion means is the communication quality parameter measured by the parameter measurement means.

3. The relay device according to claim 1, further comprising:
communication quality parameter recording means for recording information for identifying one of the communication devices serving as a transmission source of the data packet and the measured communication quality parameter in a recording unit in the relay device while linking the information for identifying the communication device serving as the transmission source to the measured communication quality parameter.

4. The relay device according to claim 3,
wherein a content described in a quality information notification packet obtained after conversion by the communication quality parameter conversion means is information for identifying other one of the communication devices serving as a transmission destination of the received quality information notification packet and the communication quality parameter linked and recorded by the communication quality parameter recording means.

5. The relay device according to claim 3,
wherein the information for identifying the transmission source is acquired from a content described in the received data packet.

6. The relay device according to claim 2,
wherein the time information points out information expressed by a sequence number and a timestamp described in the received data packet.

7. The relay device according to claim 1,
wherein the communication quality parameter is expressed by at least one of or a combination of a packet discard rate, a packet delay time, and a jitter indicating a fluctuation in a packet transfer time.

8. A communication device transmitting and receiving packets, comprising a function as the relay device according to claim 1, and further comprising:
transmission means for transmitting a data packet using a transmission method according to a communication interval based on the communication quality parameter.

9. A communication system in a network, comprising a transmission device and a receiving device communicating a data packet and a communication quality notification packet therebetween, further comprising:
the relay device according to claim 1,
wherein the relay device relays the data packet and the communication quality notification packet.

10. The communication system according to claim 9,
wherein the relay device measures a communication quality from the received data packet and then transmits the measured communication quality to the receiving device.

11. The communication system according to claim 9,
wherein the relay device converts a content described in the received communication quality notification packet into the communication quality parameter held by the relay device, and then transfers the communication quality parameter to the transmission device.

12. The communication system according to claim 9,
wherein the receiving device includes communication quality notification means for, when receiving the data packet transferred from the relay device, measuring the communication quality parameter of the data packet, and for transmitting the measured communication quality parameter to the transmission device as the communication quality notification packet.

13. The communication system according to claim 9,
wherein the transmitting device includes transmission method selection means for, when receiving the communication quality notification packet transferred from the relay device, transmitting the data packet using an appropriate transmission method based on the communication quality parameter of the communication quality notification packet.

14. The communication system according to claim 9,
wherein the communication system comprises one or a plurality of relay devices.

15. The communication system according to claim 14,
wherein the relay device or one of the plurality of relay devices further includes communication quality parameter recognition means for calculating a difference between the communication quality parameter measured by the relay device from the received data packet and the communication quality parameter described in the quality information notification packet received by the relay device, thereby recognizing a communication quality parameter in a communication interval between the relay device and another relay device adjacent to the relay device and on a receiving device side or the receiving device.

16. A relay method for relaying a packet communication between communication methods; comprising:
a communication quality parameter conversion step of converting a communication quality parameter described in a received quality information notification packet into a communication quality parameter measured by the relay device from a received data packet.

17. The relay method according to claim 16, further comprising:
a parameter measurement step of measuring a communication quality parameter based on time information described in the received data packet,
wherein the communication quality parameter used by the communication quality parameter conversion step is the communication quality parameter measured by the parameter measurement step.

18. The relay method according to claim 16, further comprising:
a communication quality parameter recording step of recording information for identifying one of the communication devices serving as a transmission source of the data packet and the measured communication quality parameter in a recording unit in the relay device while linking the information for identifying the communication device serving as the transmission source to the measured communication quality parameter.

19. The relay method according to claim 18,
wherein a content described in a quality information notification packet obtained after conversion by the communication quality parameter conversion step is information for identifying other one of the communication devices serving as a transmission destination of the received quality information notification packet and the communication quality parameter linked and recorded by the communication quality parameter recording step.

20. The relay method according to claim 18,
wherein the information for identifying the transmission source is acquired from a content described in the received data packet.

21. The relay method according to claim 17,
wherein the time information points out information expressed by a sequence number and a timestamp described in the received data packet.

22. The relay method according to claim 16,
wherein the communication quality parameter is expressed by at least one of or a combination of a packet discard rate, a packet delay time, and a jitter indicating a fluctuation in a packet transfer time.

23. A communication method for transmitting and receiving packets, comprising the relay method according to claim 16, and further comprising:
a transmission step of transmitting a data packet using a transmission method according to a communication interval based on the communication quality parameter.

24. A communication method in a network, comprising a transmission device and a receiving device communicating a data packet and a communication quality notification packet therebetween, wherein
the network includes the relay device capable of performing the relay method according to claim 16; and
the relay device relays the data packet and the communication quality notification packet.

25. The communication method according to claim 24,
wherein the relay device measures a communication quality from the received data packet and then transmits the measured communication quality to the receiving device.

26. The communication method according to claim 24,
wherein the relay device converts a content described in the received communication quality notification packet into the communication quality parameter held by the relay device, and then transfers the communication quality parameter to the transmission device.

27. The communication method according to claim 24,
further comprising a communication quality notification step of, when the receiving device receives the data packet transferred from the relay device, measuring the communication quality parameter of the data packet, and of transmitting the measured communication quality parameter to the transmission device as the communication quality notification packet.

28. The communication method according to claim 24,
further comprising a transmission method selection step of, when the transmitting device receives the communication quality notification packet transferred from the relay device, transmitting the data packet using an appropriate transmission method based on the communication quality parameter of the communication quality notification packet.

29. The communication method according to claim 24,
wherein the network comprises one or a plurality of relay devices.

30. The communication method according to claim 29,
further comprising a communication quality parameter recognition step of calculating a difference between the communication quality parameter measured by the relay device from the received data packet and the communication quality parameter described in the quality information notification packet received by the relay device, thereby recognizing a communication quality parameter in a communication interval between the relay device and another relay device adjacent to the relay device and on a receiving device side or the receiving device.

31. A relay program for relaying a packet communication between communication devices causing a computer to execute:
a communication quality parameter conversion function of converting a communication quality parameter described in a received quality information notification packet into a communication quality parameter measured by the relay device from a received data packet.

32. The relay program according to claim 31, causing a computer to execute:
a parameter measurement function of measuring a communication quality parameter based on time information described in the received data packet,
wherein the communication quality parameter used by the communication quality parameter conversion function is the communication quality parameter measured by the parameter measurement function.

33. The relay program according to claim 31, causing a computer to execute:
a communication quality parameter recording function of recording information for identifying one of the communication devices serving as a transmission source of the data packet and the measured communication quality parameter in a recording unit in the relay device while linking the information for identifying the communication device serving as the transmission source to the measured communication quality parameter.

34. The relay program according to claim 33,
wherein a content described in a quality information notification packet obtained after conversion by the communication quality parameter conversion function is information for identifying other one of the communication devices serving as a transmission destination of the received quality information notification packet and the communication quality parameter linked and recorded by the communication quality parameter recording means.

35. The relay program according to claim 33,
wherein the information for identifying the transmission source is acquired from a content described in the received data packet.

36. The relay program according to claim 32,
wherein the time information points out information expressed by a sequence number and a timestamp described in the received data packet.

37. The relay program according to claim 31,
wherein the communication quality parameter is expressed by at least one of or a combination of a packet discard rate, a packet delay time, and a jitter indicating a fluctuation in a packet transfer time.

38. A communication program transmitting and receiving packets, causing a computer to execute:
a function similar to the function which the relay program according to claim 31 causes a computer to execute; and
a transmission function of transmitting a data packet using a transmission method according to a communication interval based on the communication quality parameter.
